(19) United States
(12) Patent Application Publication
(10) Pub. No.: US 2004/0163203 A1
(43) Pub. Date: Aug. 26, 2004

(54) Car vacuum cleaner

(76) Inventor: Wen-Chang Wang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/368,552

(22) Filed: Feb. 20, 2003

(51) Int. Cl. A47L 5/24; B60S 1/64

(52) U.S. Cl. 15/344; 15/313

(57) ABSTRACT

A car vacuum cleaner has a handle pivotally joined to an upper side of a housing at a first end thereof. The handle can be moved between a first position for allowing the user to hold to lift the cleaner, under which a second end thereof is joined to the housing and a second position, under which the second end thereof is separated from the housing, and under which it is turned to a direction opposite to the first position. The handle can be hung on a window of a car while the vacuum cleaner is positioned outside the car so that small dust, particulates, and hot exhaust are discharged outside the car directly which have been sucked up and passed through the filtering net while the vacuum cleaner is working.

### BACKGROUND OF THE INVENTION

1. Field of the invention

The present invention relates to a car vacuum cleaner, more particularly one, which can be hung on windows of a car at the handle so that small dust, particulates, hot exhaust and so on are discharged outside the car directly which have been sucked up and passed through the filtering net while it is working.

2. Brief Description of the Prior Art

Referring to FIG. 6, a conventional car vacuum cleaner 3 is provided, which consists of a handle 31, and a nozzle 32 formed at the front end thereof. The users hold the handle 31, and move the nozzle 32 over inner sides of cars to suck up dirt. This vacuum cleaner is light in weight and compact sop that it can be easily moved around in the car. However, when this vacuum cleaner is being used, small dust, particulates, and hot exhaust will be discharged into the car which have been sucked up and passed through the filtering net thereof, worsening the air quality in the car, and damaging the user's health badly. Furthermore, loud noise produced by the vacuum cleaner inside the car would make the cleaning relatively an unpleasant.

### SUMMARY OF THE INVENTION

It is a main object of the present invention to provide a car vacuum cleaner, which can be hung on windows of a car so that small dust, particulates, hot exhaust and so on are discharged outside the car directly which have been sucked up and passed through the filtering net thereof while it is working.

A car vacuum cleaner of the present invention has a handle pivotally joined to an upper side of a housing at a first end thereof. The handle can be adjusted between a first position for allowing the user to hold to lift the cleaner, under which a second end thereof is joined to the housing and a second position, under which the second end thereof is separated from the housing, and under which it is turned to a direction opposite to the first position. The handle is hung on a window of a car after it has been moved to the second position for the vacuum cleaner to be positioned outside the car for use.

It is another object of the present invention to provide a car vacuum cleaner, which has a flexible host capable of being wound around a reel portion thereof without possibility of becoming loose when it is not in use.

### BRIEF DESCRIPTION OF THE DRAWINGS

The present invention will be better understood by referring to the accompanying drawings, wherein:

FIG. 1 is an exploded perspective view of the car vacuum cleaner according to the present invention,

FIG. 2 is a side view of the car vacuum cleaner of the present invention,

FIG. 3 is a cross-sectional view of the car vacuum cleaner according to the present invention,

FIG. 4 is a perspective view of the car vacuum cleaner in use according to the present invention,

FIG. 5 is a perspective view of the car vacuum cleaner of the second embodiment; and,

FIG. 6 is a perspective view of the conventional car vacuum cleaner as described in the Background.

### DETAILED DESCRIPTION OF THE PREFERRED EMBODIMENTS

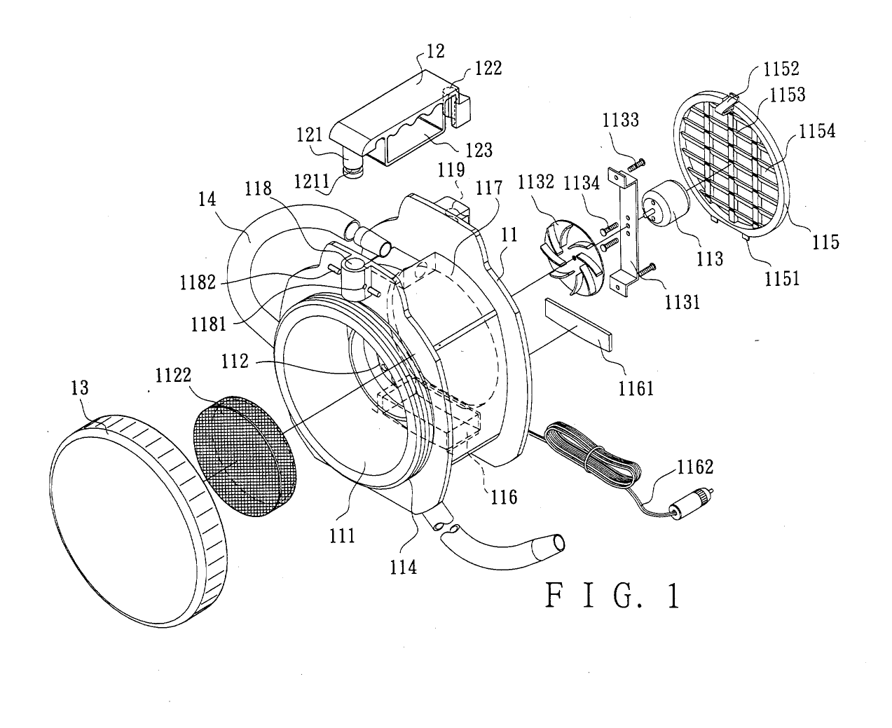

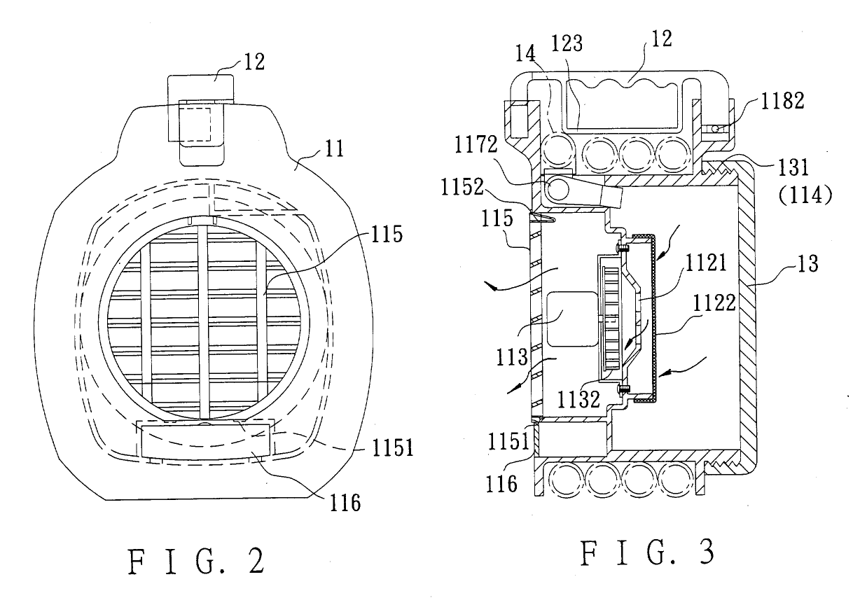

A preferred embodiment of a car vacuum cleaner in the present invention, as shown in FIGS. 1, 2, and 3, includes a housing 11, a handle 12, and a flexible host 14.

The housing 11 has a holding room 111, and a support 112 in the holding room 111. The support 112 has several vent holes 1121 for allowing air to pass through. A motor 113 and a fan 1132 are disposed in the holding room 111. A supporting plate 1131 is fixed to the support 112 by means of screws 1133, and the motor 113 is secured to the supporting plate 1131 by means of screws 1134; the shaft of the motor 113 passes through the plate 1131, and is joined to the fan 1132. A filtering net 1122 is secured to an edge of the support 112 as shown in FIG. 3.

The housing 11 has threads 114 on an outer side of an inner end, and a cover 13, which has threads 131 on an inner side, is screwed to the threaded inner end of the housing 11 to cover the opening of the inner end of the housing 11. The filtering net 1122 can be removed for replacement after the cover 13 has been separated from the housing 11.

The housing 11 has a louver 115 detachably joined to the outer end thereof; the louver 115 has several rows of spaced sloping plates 1153, and vent holes 1154 between the sloping plates 1153 so that air can be guided to outside. The louver 115 has engaging projections 1151, and a flexible plate 1152, which can engage the inner end of the housing 11 to secure the louver 115 in position.

The housing 11 is made to have a reel portion 117 between two ends thereof for allowing the flexible host 14 to pass around. The reel portion 117 has a recessed portion 1171. A tube 1172 is held in the recessed portion 1171, and communicates with the holding room 111 at one end, and is connected to the flexible host 14 at the other end.

The housing 11 has a first connecting protrusion 11 8 at the inner end, which has a central cylindrical hole, and pinholes 1181 extending from the lateral side thereof to the central cylindrical hole. The handle 12 has a connecting projection 121, which has an annular trench 1211 on a lower end. The handle 12 is pivotally connected to the housing 11 by means of inserting the connecting projection 121 into the central cylindrical hole of the first connecting protrusion 118; pins 1182 are inserted into the pinholes 1181 and the annular trench 1211 to prevent the handle 12 from separating from the housing 11.

The housing 11 has a second connecting protrusion 119 opposite to the first connecting protrusion 118. The second connecting protrusion 119 has an engaging gap while the handle 12 has an engaging protrusion 122, which is opposite to the connecting projection 121, and which can fit into the engaging gap of the second connecting protrusion 119; when the engaging protrusion 122 fits into the engaging gap of the second connecting protrusion 119, the user can lift the vacuum cleaner by the handle 12.

The handle 12 has a frame 123, which is provided for holding the flexible host 14 in position so that the host 14 cannot become loose when it is wound around the reel portion 117 of the housing 11.

The housing 11 has a cord holding chamber 116 on the bottom, in which the cord 1162 can be held when the vacuum cleaner is not used. A cover 1161 is provided for covering the cord holding chamber 116.

Referring to FIG. 3, when the motor 113 is powered to rotate the fan 1132, air is forced to travel through the filtering net 1122, the vent holes 1121 and the louver 115 to outside while dust, which is in the air or sucked up via the host 14, is stopped by the filtering net 1122. And, when the engaging protrusion 122 of the handle 12 is joined to the second connecting protrusion 119 of the housing 11, the user can lift the vacuum cleaner by the handle 12 in using the cleaner.

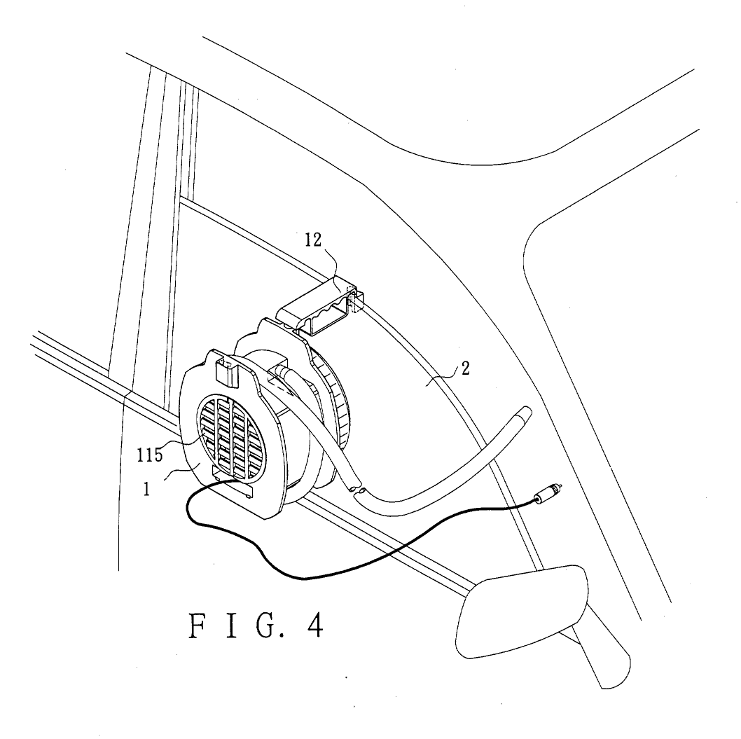

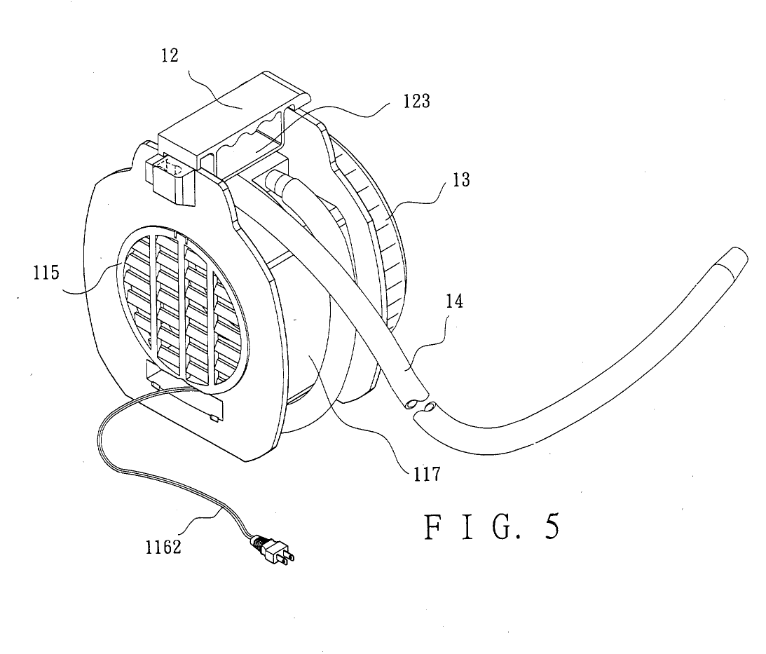

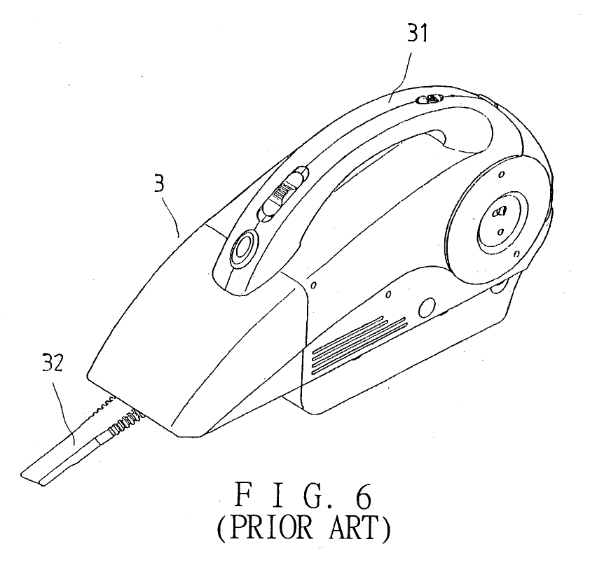

Referring to FIG. 4, the present vacuum cleaner is hung on the window of a car at the handle 12 after the engaging protrusion 122 of the handle 12 has been separated from the second connecting protrusion 119 of the housing 11, and after the handle 12 has been turned for one hundred and eighty degrees. Thus, small dust, particulates, hot exhaust and so on are discharged outside the car directly which have been sucked up and passed through the filtering net 1122 while the vacuum cleaner is working. And, most of noise produced by the vacuum cleaner is kept outside the car because the vacuum cleaner is positioned outside the car.

When the vacuum cleaner is not in use, the flexible host 14 is wound around the reel portion 117 of the housing 11, and the engaging protrusion 122 of the handle 12 is joined to the second connecting protrusion 119 of the housing 11 so that the frame 123 of the handle 12 can hold the host 14 in position, preventing the host 14 from becoming loose.

If the motor 113 needs repair or replacement, the louver 115 has to be first removed from the housing 11 for allowing access to the motor 113.

From the above description, it can be easily understood that the vacuum cleaner of the present invention has advantages as followings:

1. The vacuum cleaner can be hung on windows of a car to be placed outside the car therefore small dust, particulates, hot exhaust and so on are discharged outside the car directly which have been sucked up and passed through the filtering net while the vacuum cleaner is working. In other words, such small dust, particulates, and hot exhaust cannot cause damage to the health of a user using the vacuum cleaner in the car. And, most of noise produced by the vacuum cleaner is kept outside the car, not going to make the cleaning an unpleasant job.

2. Because the host is flexible, the present vacuum cleaner can suck up dust on comers inside a car more easily than the prior vacuum cleaner as described in the Background.

3. When the flexible host is wound around the reel portion of the housing, the frame 123 of the handle 12 can hold the host 14 in, position, preventing the host 14 from falling loose to look messy. Therefore, the vacuum cleaner is easy to store when it is not used.

What is claimed is:

1. A car vacuum cleaner, comprising:
a housing having a holding room;
a fan and a motor disposed in the housing for forcing air to travel through the housing;
a filtering net disposed in the housing for filtering out dirt from air traveling through the housing;
a flexible host joined to the holding room of the housing; and
a handle joined to the housing;
and being characterized by:
(a) the handle being formed with a connecting projection at one end as well as an engaging protrusion at other end; the connecting projection having an annular trench; the handle being pivotal on the housing with the connecting projection being inserted into a cylindrical hole of a first connecting protrusion of the housing; the handle being stopped from falling out of the housing with pins, which are inserted into pin holes of the first connecting protrusion of the housing as well as the annular trench; the handle being fixed in position for allowing the vacuum cleaner to be lifted in use by means of fitting the engaging protrusion thereof into a gap of a second connecting protrusion of the housing;
(b) the housing being formed with a reel portion for allowing the flexible host to be wound around as well as a recessed portion on the reel portion; a tube being joined to the flexible host at one end, and disposed in the recessed portion to communicate with the holding room of the housing at other end;
whereby the vacuum cleaner can be hung on a window of a car at the handle thereof to be used while being positioned outside the car.

2. The car vacuum cleaner as claimed in claim 1, wherein the handle has a frame formed between two ends for preventing, when the engaging protrusion of the handle is fitted in the gap of the second connecting protrusion of the housing, the flexible host from falling loose after the host is wound around the reel portion of the housing.
